(19) United States
(12) Patent Application Publication
(10) Pub. No.: US 2026/0283185 A1
(43) Pub. Date: Sep. 24, 2026

(54) GUM BASE FOR BUBBLE GUM

(71) Applicant: LOTTE CO., LTD., Shinjuku-ku, Tokyo (JP)

(72) Inventors: Tatsuhiro URABE, Saitama-shi (JP); Sho KOMAKI, Saitama-shi (JP); Ryoga HIGAKI, Saitama-shi (JP); Hironobu NAGAYASU, Saitama-shi (JP); Daisuke TAKAHASHI, Saitama-shi (JP)

(21) Appl. No.: 19/477,469

(22) PCT Filed: Apr. 17, 2024
(86) PCT No.: PCT/JP2024/015280

§ 371 Date: Oct. 21, 2025

(30) Foreign Application Priority Data
Apr. 28, 2023 (JP) 2023-075074

(51) Int. Cl. A23G 4/08; A23G 4/06

(52) U.S. Cl. CPC A23G 4/08; A23G 4/068

(57) ABSTRACT

To provide a bubble gum that is superior in manufacturing suitability and stability of the film compared to conventional ones. A gum base for bubble gum, characterized by not containing a vinyl acetate resin having a degree of polymerization of less than 500, and containing a vinyl acetate resin having a degree of polymerization of 750 or more and natural rubber.

### TECHNICAL FIELD

The present invention relates to a gum base for bubble gum.

### BACKGROUND ART

Among chewing gums, what is known as “bubble gum” is intended for playing by inflating the gum; for this reason, physical properties are required such that the gum base, which is the residue after chewing, is easy to inflate when breath is blown into it, and the resulting bubble film is resistant to breaking when inflated.

Conventionally, compositions based mainly on vinyl acetate resin, which is excellent in stretchability and film strength, have been used for gum bases for bubble gum. However, although a vinyl acetate resin with a high degree of polymerization (1000 or more) has favorable properties in terms of increasing the film strength when inflated into a bubble, it has drawbacks in terms of manufacturing suitability (such as miscibility and fluidity of raw materials) and quality (such as uniformity and stability of the film); therefore, generally, a vinyl acetate resin with a low to medium degree of polymerization (about 400 to 600) was often used alone, or a vinyl acetate resin with a low degree of polymerization (about 100 to 200) was often used in combination with a vinyl acetate resin with a medium degree of polymerization (about 500 to 800).

In contrast to this, a bubble gum (Patent Literature 1) has been proposed in which the maximum inflation volume when inflated into a bubble is increased to two to three times that of conventional bubble gum by using a mixture of vinyl acetate resins with a high degree of polymerization (1000 to 7000) and a low degree of polymerization (100 to 250). In addition, a gum base composition made non-adhesive by including a homogeneous premix of a vinyl acetate polymer having a molecular weight of about 38,000 to about 94,000 (corresponding to a degree of polymerization of 440 to 1100) and an emulsifier (Patent Literature 2), and a chewing gum composition that achieves both cohesiveness (quality) and fluidity (manufacturing suitability) by using in combination a gum base made by adding a non-hygroscopic plasticizer to a vinyl acetate resin having a molecular weight of about 20,000 or more (corresponding to a degree of polymerization of 290 or more) and a cohesive sweetening-bulking component (Patent Literature 3) have been proposed.

Furthermore, bubble gum base compositions with improved texture and shelf life have also been proposed (Patent Literature 4, 5), in which an elastomer such as synthetic rubber or natural rubber and an acetylated monoglyceride are used in combination with a mixture of vinyl acetate resins of a low molecular weight of about 12,000 to about 16,000 (corresponding to a degree of polymerization of 140 to 190) and a medium molecular weight of about 35,000 to about 55,000 (corresponding to a degree of polymerization of 410 to 640).

### CITATION LIST

### Patent Literature

PTL 1: Japanese Examined Patent Publication No. Sho 63-66497

PTL 2: Japanese Examined Patent Publication No. Hei 3-51382

PTL 3: Japanese Patent Application Laid-Open No. Sho 62-195251

PTL 4: Japanese Examined Patent Publication No. Hei 3-71098

PTL 5: Japanese Patent Application Laid-Open No. Hei 3-172143

### SUMMARY OF INVENTION

### Technical Problem

As described above, bubble gum has been manufactured by either avoiding the use of a vinyl acetate resin with a high degree of polymerization (degree of polymerization of 1000 or more) or in a way that compensates for its drawbacks, but conventional bubble gums could not be said to be fully satisfactory in terms of manufacturing suitability and stability of the film. In view of this point, an object of the present invention is to provide a bubble gum that is superior in manufacturing suitability and stability of the film compared to conventional ones.

### Solution to Problem

The present invention provides a gum base for bubble gum that does not contain a vinyl acetate resin having a degree of polymerization of less than 500, and contains a vinyl acetate resin having a degree of polymerization of 750 or more and natural rubber, thereby solving the above-mentioned problem.

### Advantageous Effects of Invention

The gum base for bubble gum of the present invention has favorable physical properties in terms of manufacturing suitability, and when used to produce bubble gum, the stability of the bubble film is improved compared to conventional ones.

### DESCRIPTION OF EMBODIMENTS

The gum base for bubble gum of the present invention is characterized by not containing a vinyl acetate resin having a degree of polymerization of less than 500, and containing a vinyl acetate resin having a degree of polymerization of 750 or more and natural rubber. There is no problem even if a vinyl acetate resin having a degree of polymerization of 500 or more and less than 750, which is an intermediate degree of polymerization between the above two types of vinyl acetate resins, is included; rather, it can be said that its inclusion is preferable in that it improves the chewing feel.

Since a polymer such as vinyl acetate resin (polyvinyl acetate) is generally a polydisperse system having a molecular weight distribution, its degree of polymerization is usually expressed as an average degree of polymerization. There are number-average degree of polymerization, weight-average degree of polymerization, viscosity-average degree of polymerization, z-average degree of polymerization, and the like as the average degree of polymerization; in the present invention, the weight-average degree of polymerization, which can be measured by Gel Permeation Chromatography (GPC), is adopted.

Generally, a gum base is produced by mixing one or two or more types of raw material resins; the phrase “does not contain a vinyl acetate resin having a degree of polymerization of less than 500” means that a vinyl acetate resin having a weight-average degree of polymerization of less than 500 is not used as a raw material for the gum base. The phrase “contains a vinyl acetate resin having a degree of polymerization of 750 or more” means that a vinyl acetate resin having a weight-average degree of polymerization of 750 or more is used as a raw material for the gum base. Therefore, the weight-average degree of polymerization of the entire vinyl acetate resin in the gum base of the present invention (hereinafter simply referred to as “degree of polymerization”) will be 750 or more when only a vinyl acetate resin with a degree of polymerization of 750 or more is used as a raw material, but will not necessarily be 750 or more when a vinyl acetate resin with a degree of polymerization of 500 or more and less than 750 is also used in combination. However, the degree of polymerization of the entire vinyl acetate resin in the gum base of the present invention will not be less than 500.

The gum bases of conventional bubble gums have been used in a manner that compensates for the drawbacks related to manufacturing suitability and stability of the bubble film caused by using a high-degree-of-polymerization vinyl acetate resin, by either not containing a high-degree-of-polymerization vinyl acetate resin with a degree of polymerization of 1000 or more, or, when containing a high-degree-of-polymerization vinyl acetate resin with a degree of polymerization of 1000 or more, by also combining it with a low-degree-of-polymerization vinyl acetate resin with a degree of polymerization of less than 500. However, although the inclusion of a low-degree-of-polymerization vinyl acetate resin improves the chewing feel and ease of inflation, it is disadvantageous for increasing the maximum inflation volume (the upper limit of the size to which a bubble can be inflated) because the proportion of the high-degree-of-polymerization vinyl acetate resin that relatively increases film strength is reduced.

It is presumed that, in the gum base for bubble gum of the present invention, rather than containing a low-degree-of-polymerization vinyl acetate resin with a degree of polymerization of less than 500 and instead containing natural rubber, which is a polymer but has smoother physical properties compared to synthetic rubber, the problems related to manufacturing suitability and stability of the film caused by using a medium- to high-degree-of-polymerization vinyl acetate resin with a degree of polymerization of 750 or more are resolved, and the problem of a decrease in film strength caused by using a low-degree-of-polymerization vinyl acetate resin is also avoided.

As stated above, it seems that, generally, a high-degree-of-polymerization vinyl acetate resin refers to one with a degree of polymerization of 1000 or more, a medium-degree-of-polymerization vinyl acetate resin refers to one with a degree of polymerization of 500 or more and less than 1000, and a low-degree-of-polymerization vinyl acetate resin refers to one with a degree of polymerization of less than 500. However, the gum base for bubble gum of the present invention does not contain a low-degree-of-polymerization vinyl acetate resin with a degree of polymerization of less than 500, and contains a vinyl acetate resin with a degree of polymerization of 750 or more and natural rubber. For this reason, in the following description of this specification, a vinyl acetate resin with a degree of polymerization of 750 or more will be referred to as a “high-degree-of-polymerization resin,” a vinyl acetate resin with a degree of polymerization of 500 or more and less than 750 will be referred to as a “medium-degree-of-polymerization resin,” and a vinyl acetate resin with a degree of polymerization of less than 500 will be referred to as a “low-degree-of-polymerization resin.”

The gum base for bubble gum of the present invention preferably contains about 4 to 20% by weight of the high-degree-of-polymerization resin, and more preferably contains about 12 to 15% by weight. As stated above, it is preferable that the gum base for bubble gum of the present invention contains the medium-degree-of-polymerization resin in addition to the high-degree-of-polymerization resin. In that case, the medium-degree-of-polymerization resin is preferably contained in the gum base in an amount of about 0 to 35% by weight, and more preferably contained in an amount of about 10 to 20% by weight. The total amount of the high-degree-of-polymerization resin and the medium-degree-of-polymerization resin in the gum base is preferably about 15 to 40% by weight.

The gum base for bubble gum of the present invention contains natural rubber in addition to the high-degree-of-polymerization resin (and the medium-degree-of-polymerization resin). Natural rubber refers to what is refined by coagulating, washing, dehydrating, and drying the sap (latex) of the rubber tree, and is chemically a high-cis polyisoprene (a polyisoprene mostly composed of cis-type isoprene monomers).

The gum base for bubble gum of the present invention preferably contains about 2 to 9% by weight of natural rubber, and more preferably contains about 4 to 9% by weight. If the content of natural rubber is less than 2% by weight, the effect of adding natural rubber is not exhibited, therefore an improvement in manufacturing suitability cannot be expected, and it becomes difficult to inflate a bubble even if bubble gum is formed using it. If the content of natural rubber is 4% by weight or more, more favorable manufacturing suitability is obtained, and if it is made into bubble gum, a bubble can be inflated more smoothly. On the other hand, if the content of natural rubber exceeds 9% by weight, the physical properties of the gum become too hard, and the supple extensibility of the bubble is impaired, which makes it difficult to inflate a large bubble.

The gum base for bubble gum of the present invention can contain, in addition to the vinyl acetate resin and natural rubber, synthetic rubbers such as polyisobutylene and polybutene, waxes such as microcrystalline wax and candelilla wax, emulsifiers such as glycerin fatty acid esters and lecithin, fillers such as talc and calcium carbonate, or ester gum and the like. The blending amounts of these additive substances are usually about 3 to 25% by weight for synthetic rubber, 10 to 25% by weight for waxes, 5 to 25% by weight for emulsifiers, 5 to 30% by weight for fillers, and 0 to 25% by weight for ester gum.

A bubble gum product can be obtained by using the gum base for bubble gum of the present invention, adding thereto usual bubble gum additives such as saccharides (sugar, glucose, starch syrup, etc.), sweeteners (xylitol, etc.), flavors, colorants, and the like, kneading the mixture, passing it through an extruder, and then cutting and molding it into a plate shape, a block shape, a spherical shape, or the like.

The ease of inflating a bubble gum is usually evaluated by a sensory test by a panel consisting of multiple panelists, but it can also be evaluated separately by chewing the gum until the sweetness disappears (usually for about 10 to 15 minutes) and then measuring the water content (% by weight) and compressive load (kgf) of the gum residue. Generally, the higher the water content of the gum residue, the more smoothly the bubble inflates. For the bubble gum using the gum base of the present invention, the water content suitable for inflating a bubble is preferably 18.0% or more, more preferably 20.0% or more, and even more preferably 22.0% or more. A larger compressive load of the gum residue means stronger film strength, allowing a larger bubble to be inflated, but if the compressive load is too large, excessive breath pressure is required to inflate the bubble. The maximum compressive load is preferably 2.0 kgf or more, and more preferably 2.1 kgf or more. It is particularly preferable that the water content is 18.0% or more and the maximum compressive load is 2.0 kgf or more.

The limit to how large a bubble can be inflated when using a specific bubble gum (maximum inflation volume) can be determined by an inflation test by skilled panelists, but it can be evaluated more objectively if measured with an apparatus that can optimally adjust the gas pressure and inflow rate. The bubble gum using the gum base of the present invention exhibits a maximum inflation volume of two times or more when compared with conventional bubble gum under the same conditions, suggesting that its film stability is high.

### EXAMPLES

### Example 1

A vinyl acetate resin with a molecular weight of 55,000 to 75,000 (average degree of polymerization: about 750) was prepared as the high-degree-of-polymerization resin, a vinyl acetate resin with a molecular weight of 47,000 to 57,000 (average degree of polymerization: about 580) was prepared as the medium-degree-of-polymerization resin, and a vinyl acetate resin with a molecular weight of 12,000 to 18,000 (average degree of polymerization: about 180) was prepared as the low-degree-of-polymerization resin.

Using a 3 L kneader with a heater, each component was combined in the following ratios (unit: % by weight) shown in Table 1, and heated, melted, and mixed at 135° C. for 50 minutes to produce a gum base.

| | |
|---|---|
| Resin mixture: | 29.2 |
| (of which, low-degree-of-polymerization resin: 0.0) | |
| (of which, medium-degree-of-polymerization resin: 15.3) | |
| (of which, high-degree-of-polymerization resin: 13.9) | |
| Rubber content: | 9.0 |
| (of which, natural rubber: 2.3) | |
| Other components: | |
| Ester gum: | 24.4 |
| Wax: | 20.8 |
| Emulsifier: | 10.0 |
| Filler: | 6.6 |
| Total: | 100.0 |

### Examples 2-4, Comparative Examples 1-3

Gum bases were produced in the same manner as in Example 1, except that the blending ratios of each component were changed as shown in Table 1.

### Evaluation of Examples 1~4 and Comparative Examples 1-3

### <Evaluation of Manufacturing Suitability>

The ease of manufacturing when producing the gum bases in Examples 1~4 and Comparative Examples 1-3 was evaluated according to the following criteria.

A: The raw materials were well-miscible, and the manufacturing suitability was good.

B: The raw materials were not sufficiently miscible, there was graininess, and the manufacturing suitability was not very good.

C: The raw materials were not miscible, and it was not possible to produce a gum base.

The evaluation results are shown in Table 2.

### <Evaluation of Gum Using Gum Base>

To the gum bases produced in Examples 1~4 and Comparative Examples 1-3, a mixture was kneaded at a ratio of 42% gum base, 36% sugar, 13% starch syrup, 4% softener, 2.5% acidulant, 1.3% flavor, 1% gelatin, 0.1% antioxidant, and 0.1% colorant for each; after being molded into a spherical shape, a sensory evaluation test and, as objective evaluations, an evaluation of the maximum inflation volume and measurements of water content and compressive load were performed.

### <Sensory Evaluation Test>

Three panelists were asked to chew the gum using the gum bases produced in each of Examples 1~4 and Comparative Examples 1-3 for 3 minutes, then inflate the chewed gum into a bubble, and evaluate whether it inflated to a large size according to the following five-level criteria; the arithmetic mean of the evaluation results of all panelists was taken as the evaluation result.

1: Does not inflate at all.

2: Does not inflate much.

3: Inflates fairly well.

4: Inflates well.

5: Inflates extremely well.

The results are shown in Table 2.

### <Evaluation of Maximum Inflation Volume (Film Stability)>

Using a test apparatus having a sample mounting part made to imitate the human oral cavity, a gas supply part that supplies gas to the sample mounting part, and a flow rate control device part that controls the flow rate of the supplied gas, the film stability was evaluated by measuring the maximum inflation volume for the gums using the gum bases produced in each of Examples 1-4 and Comparative Examples 1-3.

Specifically, each sample chewed for 10 to 15 minutes was attached to the sample mounting part of the test apparatus, nitrogen gas was flowed at an optimal flow rate (L/min) confirmed in a preliminary test, and the total flow rate (mL) until the sample could no longer inflate was measured. The measurement was performed 10 times for each sample, and the arithmetic mean was taken. The results are shown in Table 2.

### <Measurement of Water Content>

The water content was measured for the gums using the gum bases produced in each of Examples 1~4 and Comparative Examples 1-3 by the following procedure. That is, after chewing 3 g of each sample for 15 minutes at a speed of 80 times/min, the weight of the chewed material was immediately weighed. Next, the weight of the dried chewed material, obtained by vacuum drying the chewed material at 105° C. for 1 hour, was weighed, and the water content was calculated by the following formula.

$$Water content ( \% ) = 100 - ( weight of dried chewed material / weight of chewed material \times 100 )$$

The measurement was performed 3 times for each sample, and the arithmetic mean was taken. The results are shown in Table 2.

### <Measurement of Compressive Load>

The compressive load was measured for the gums using the gum bases prepared in each of Examples 1~4 and Comparative Examples 1-3 by the following procedure. That is, after chewing 3 g of each sample for 15 minutes at a speed of 80 times/min, the chewed material was sandwiched between wax paper and molded to a thickness of 3.2 mm. Then, 20 seconds after taking the chewed material out of the mouth, the compressive load was measured under the following conditions. That is, using a universal testing machine 68SC-05 manufactured by Instron, a sample was compressed with a stainless steel hemispherical plunger with a diameter of 20 mm at a speed of 2 mm/sec and a clearance of 0.3 mm; after holding for 0.1 seconds, the maximum compressive load (kgf) when the plunger was raised at a speed of 2 mm/sec was measured. The measurement environment was set to 30° C. using a precision air conditioner and a temperature-controlled stage. The measurement was performed 3 times for each sample, and the arithmetic mean was taken. The results are shown in Table 2.

TABLE 1
Gum Base Formulation

| Blended Components | Example | | | |
|---|---|---|---|---|
| (Unit: % by weight) | 1 | 2 | 3 | 4 |
| High-degree-of-polymerization resin | 13.9 | 13.6 | 13.3 | 13.0 |
| Medium-degree-of-polymerization resin | 15.3 | 14.9 | 14.6 | 14.3 |
| Low-degree-of-polymerization resin | 0.0 | 0.0 | 0.0 | 0.0 |
| Vinyl acetate resin total | 29.2 | 28.5 | 27.9 | 27.3 |
| Natural rubber | 2.3 | 4.6 | 6.7 | 8.4 |
| Synthetic rubber | 6.7 | 6.5 | 6.4 | 6.2 |
| Rubber content total | 9.0 | 11.1 | 13.1 | 14.6 |
| Ester gum | 24.4 | 23.9 | 23.3 | 22.9 |
| Wax | 20.8 | 20.3 | 19.8 | 19.6 |
| Emulsifier | 10.0 | 9.7 | 9.5 | 9.4 |
| Filler | 6.6 | 6.5 | 6.4 | 6.2 |
| Other components total | 61.8 | 60.4 | 59.0 | 58.1 |
| Total | 100.0 | 100.0 | 100.0 | 100.0 |

| Blended Components | Comparative Example | | |
|---|---|---|---|
| (Unit: % by weight) | 1 | 2 | 3 |
| High-degree-of-polymerization resin | 3.9 | 3.8 | 14.2 |
| Medium-degree-of-polymerization resin | 13.3 | 13.2 | 15.6 |
| Low-degree-of-polymerization resin | 8.7 | 8.6 | 0.0 |
| Vinyl acetate resin total | 25.9 | 25.6 | 29.8 |
| Natural rubber | 0.0 | 6.3 | 0.0 |
| Synthetic rubber | 9.5 | 3.8 | 6.8 |
| Rubber content total | 9.5 | 10.1 | 6.8 |
| Ester gum | 13.5 | 13.4 | 25.0 |
| Wax | 18.5 | 18.6 | 21.3 |
| Emulsifier | 21.0 | 20.8 | 10.3 |
| Filler | 11.6 | 11.5 | 6.8 |
| Other components total | 64.6 | 64.3 | 63.4 |
| Total | 100.0 | 100.0 | 100.0 |

TABLE 2
Evaluation Results

| | Example | | | |
|---|---|---|---|---|
| Evaluation Item | 1 | 2 | 3 | 4 |
| Manufacturing Suitability | B | A | A | A |
| Ease of Inflation | 1.2 | 3.8 | 4.3 | 4.3 |
| Film Stability (mL) | 2312 | 3578 | 4138 | 3589 |
| Water Content (%) | 18.2 | 20.7 | 22.2 | 23.6 |
| Maximum Compressive Load (kgf) | 2.4 | 2.2 | 2.1 | 2.4 |

Comparative Example

| Evaluation Item | 1 | 2 | 3 |
|---|---|---|---|
| Manufacturing Suitability | A | A | C |
| Ease of Inflation | 3.3 | 3.2 | — |
| Film Stability (mL) | 707 | 1049 | — |
| Water Content (%) | 19.7 | 23.1 | — |
| Maximum Compressive Load (kgf) | 1.4 | 1.9 | — |

(—: Not measurable)

### INDUSTRIAL APPLICABILITY

By using the gum base for bubble gum of the present invention, it is possible to produce a bubble gum that inflates into a larger bubble compared to conventional bubble gum.

### Aspects of the Invention

The various aspects of the present invention include the following.

1. A gum base for bubble gum, characterized by not containing a vinyl acetate resin having a degree of polymerization of less than 500, and containing a vinyl acetate resin having a degree of polymerization of 750 or more and natural rubber.

2. The gum base for bubble gum according to 1, wherein the vinyl acetate resin having a degree of polymerization of 750 or more is contained in an amount of 12 to 15% by weight.

3. The gum base for bubble gum according to 1 or 2, wherein the natural rubber is contained in an amount of 2 to 9% by weight.

4. The gum base for bubble gum according to 1 or 2, wherein the natural rubber is contained in an amount of 4 to 9% by weight.

5. The gum base for bubble gum according to any one of 1 to 4, further containing a vinyl acetate resin having a degree of polymerization of 500 to 750.

6. The gum base for bubble gum according to 5, wherein the vinyl acetate resin having a degree of polymerization of 500 to 750 is contained in an amount of 10 to 20% by weight.

7. The gum base for bubble gum according to any one of 1 to 6, further containing at least one component selected from the group consisting of synthetic rubber, waxes, emulsifiers, fillers, and ester gum.

8. A bubble gum, comprising the gum base for bubble gum according to any one of 1 to 7 and usual bubble gum components.

9. The bubble gum according to 8, wherein a water content after chewing is 18% or more and a maximum compressive load is 2.0 kgf or more.

This application claims priority from Japanese Patent Application No. 2023-075074, filed on Apr. 28, 2023, the contents of which are incorporated herein by reference.

1. A gum base for bubble gum, characterized by not containing a vinyl acetate resin having a degree of polymerization of less than 500, and containing a vinyl acetate resin having a degree of polymerization of 750 or more and natural rubber.

2. The gum base for bubble gum according to claim 1, wherein the vinyl acetate resin having a degree of polymerization of 750 or more is contained in an amount of 12 to 15% by weight.

3. The gum base for bubble gum according to claim 1, wherein the natural rubber is contained in an amount of 2 to 9% by weight.

4. The gum base for bubble gum according to claim 1, wherein the natural rubber is contained in an amount of 4 to 9% by weight.

5. The gum base for bubble gum according to claim 1, further comprising a vinyl acetate resin having a degree of polymerization of 500 to 750.

6. The gum base for bubble gum according to claim 5, wherein the vinyl acetate resin having a degree of polymerization of 500 to 750 is contained in an amount of 10 to 20% by weight.

7. The gum base for bubble gum according to claim 1, further comprising at least one component selected from the group consisting of synthetic rubber, waxes, emulsifiers, fillers, and ester gum.

8. A bubble gum, comprising the gum base for bubble gum according to claim 1 and usual bubble gum components.

9. The bubble gum according to claim 8, wherein a water content after chewing is 18% or more and a maximum compressive load is 2.0 kgf or more.
